(19) United States
(12) Patent Application Publication
(10) Pub. No.: US 2025/0132484 A1
(43) Pub. Date: Apr. 24, 2025

(54) MULTI-FUNCTIONAL LINK ASSEMBLY FOR SMALL CELL BASE STATION ANTENNA APPARATUS

(71) Applicant: KMW INC., Hwaseong-si (KR)

(72) Inventors: Duk Yong KIM, Yongin-si (KR); Kyo Sung JI, Hwaseong-si (KR); Hee KIM, Osan-si (KR)

(73) Assignee: KMW INC., Hwaseong-si (KR)

(21) Appl. No.: 18/986,737

(22) Filed: Dec. 19, 2024

Related U.S. Application Data
(63) Continuation of application No. PCT/KR2023/008776, filed on Jun. 21, 2023.

(30) Foreign Application Priority Data
Jun. 24, 2022 (KR) 10-2022-0077743
Jun. 20, 2023 (KR) 10-2023-0078909

(51) Int. Cl. H01Q 1/12

(52) U.S. Cl. CPC H01Q 1/125

(57) ABSTRACT

The present invention relates to a small cell base station antenna apparatus and, more particularly, comprises: a rotatable housing having an internal space open in the back/forth direction; a steering ball joint unit coupled to the rear side of the open internal space of the rotatable housing and guiding the rotatable housing to enable steering rotation in thereof the horizontal direction with reference to an arbitrary rotation center point in the internal space of the rotatable housing; a tilting ball joint unit which is coupled to the front side of the open internal space of the rotatable housing, and tilted and rotated in the vertical direction while the front end thereof, to which an antenna module is coupled, is guided by the rotatable housing with reference to the arbitrary rotation center point of the internal space; and a multi-strand coaxial cable provided for electrical connection between a radio unit (RRH) and the antenna module.

### TECHNICAL FIELD

The present disclosure relates to a multifunction link assembly for small cell base station antenna apparatuses, and more particularly, to a multifunction link assembly for small cell base station antenna apparatuses, which is capable of preventing external exposure of cables, of facilitating establishment of indoor small cells, and of realizing beamforming to enable multiband implementation by dividing a portion of one antenna module to cover different frequency bands or by providing a plurality of antenna modules to cover respective different frequency bands.

### BACKGROUND ART

In order to meet the growing demand for wireless data traffic since the commercialization of 4G communication systems, efforts are being made to develop improved 5G communication systems or pre-5G communication systems. For this reason, the 5G communication systems or the pre-5G communication systems are called beyond 4G network communication systems or post LTE communication systems. In order to achieve high data rates, the 5G communication systems are considered for implementation in ultra-high frequency (mmWave) bands (e.g., 60 gigahertz (60 GHz) bands). In order to mitigate the path loss of radio waves and increase the distance of transmission of radio waves in ultra-high frequency bands, beamforming, massive MIMO, full-dimensional MIMO (FD-MIMO), array antenna, analog beamforming, and large scale antenna technologies are discussed in the 5G communication systems.

In particular, various technologies for enhancing frequency efficiency are applicable in future 5G cellular networks that require much higher capacity than the current one. One of several technology candidates, small cell network (SCN) technology, may miniaturize the size of cells to enhance channel utilities, increase the density of cells to improve frequency efficiency, and increase capacity.

Unlike an existing macro cell that has wide coverage with high transmission power, a small cell is a small base station that has narrow coverage with low transmission power. The category of the small cell collectively refers to low-power base station equipment of 10 W or less, pico cells, femto cells, Wi-Fi, etc. The advantage of the small cell is that it is able to cost less to establishment and to be smaller in size to enhance space efficiency, compared to the macro cell.

Overlapping such small cells in public places, densely populated areas, or indoor spaces such as large shopping malls or airport buildings may increase capacity per unit area. This also has an advantage of reducing the power consumption and installation costs of one macro cell base station. It is expected that this small cell will be foundation technology that connects 4G and 5G, as small cell base stations alone may achieve 1,000 times the capacity of existing LTE.

A base station apparatus according to the prior art is installed outdoors (outside), and structured such that an antenna module is mounted to an upright support pole by fixing brackets, a radio unit (e.g., remote radio head (RRH)) is mounted beneath the antenna module by fixing brackets, and the antenna module is electrically connected to the radio unit using a plurality of cables.

However, the conventional base station antenna apparatus needs to have a limited structure that should necessarily be installed outdoors (outside) via the support pole, and may have a poor aesthetic appearance due to the external exposure of the cables as it is structured such that the antenna module is mounted on the relatively upper side of the support pole, the radio unit, e.g., the RRH, is mounted on the relatively lower side of the support pole, and they are then interconnected using the cables.

If a small cell base station is installed indoors in this way, the complex connection of cables between a remote radio head (RRH) and an antenna module may cause a poor aesthetic appearance, and it may be realistically difficult to cover dual-band frequency ranges because only one antenna module is provided for each remote radio head (RRH).

### DISCLOSURE

### Technical Problem

The present disclosure has been made in view of the above-mentioned problems, and an object thereof is to provide a multifunction link assembly for small cell base station antenna apparatuses, which is capable of facilitating establishment of small cell base stations in public places, densely populated areas, or places such as large shopping malls or airport buildings.

Another object of the present disclosure is to provide a multifunction link assembly for small cell base station antenna apparatuses, which is capable of preventing a poor aesthetic appearance (aesthetic external appearance) by having controllable directionality without exposure of various cables for electrical connection between a radio unit and an antenna module to the outside.

Still another object of the present disclosure is to provide a multifunction link assembly for small cell base station antenna apparatuses, which is capable of achieving dual banding in various places by dividing a portion of one antenna module to cover different frequency bands or by providing a plurality of antenna modules to cover respective different frequency bands.

A further object of the present disclosure is to provide a multifunction link assembly for small cell base station antenna apparatuses, which is capable of mediating installation of a plurality of antenna modules to a radio unit and of ensuring a wide range of directional control angles.

The present disclosure is not limited to the above-mentioned objects, and other objects of the present disclosure can be clearly understood by those skilled in the art from the following description.

### Technical Solution

In accordance with an aspect of the present disclosure, there is provided a multifunction link assembly for small cell base station antenna apparatuses, which includes a rotating housing having an internal space that is open in back and forth directions, a steering ball joint part coupled to the internal space at the open rear of the rotating housing, and configured to guide the rotating housing to be steerable and rotatable in left and right directions about an arbitrary rotation center point (hereinafter, referred to as a “steering rotation point”) in the internal space, a tilting ball joint part coupled to the internal space at the open front of the rotating housing, and having a front end to which an antenna module is coupled, the front end being tilted and rotated in up and down directions about an arbitrary rotation center point (hereinafter, referred to as a “tilting rotation point”) in the internal space while being guided by the rotating housing, and a multi-strand coaxial cable provided for electrical between a radio unit (e.g., remote radio head (RRH)) and the antenna module, wherein the multi-strand coaxial cable is connected to the antenna module through all of the steering ball joint part, the rotating housing, and the tilting ball joint part from the radio unit.

The steering rotation point and the tilting rotation point may be set at the same position in the internal space.

The steering ball joint part and the tilting ball joint part may be arranged so as not to interfere with each other in the internal space during steering rotation and tilting rotation.

The steering ball joint part may have at least a portion of a circular outer peripheral surface that is concentric with an inner peripheral surface of the rotating housing, and the outer peripheral surface may be formed to have the steering rotation point about which the rotating housing steered and rotated in the left and right directions.

The tilting ball joint part may have at least a portion of a circular outer peripheral surface that is concentric with an inner peripheral surface of the rotating housing, and the outer peripheral surface may be formed to have the tilting rotation point about which the tilting ball joint part is tilted and rotated in the up and down directions with respect to the rotating housing.

The antenna module may be adjusted for steering rotation in conjunction with an angle of left-right steering rotation of the rotating housing, and may be adjusted for tilting rotation in conjunction with an angle of up-down tilting rotation of the tilting ball joint part with respect to the rotating housing.

The tilting ball joint part and the steering ball joint part may include respective inner joints accommodated in the internal space of the rotating housing. The inner joints may be in contact with an inner surface of the rotating housing with a frictional force that allows rotation thereof only with respect to an additional external force provided after they are adjusted to an angle of steering rotation and an angle of tilting rotation with respect to the rotating housing while the antenna module is mounted.

At least one friction sealing member may be interposed between the inner joints and the rotating housing.

The friction sealing member may include one or more waterproof seals installed at a front tilting inlet of the rotating housing as the open front of the rotating housing and at a rear steering inlet of the rotating housing as the open rear of the rotating housing, through which the inner joints are inserted, and one or more friction rollers rolled in a direction of rotational of the inner joints.

The rotating housing may be provided with an upper drain and a lower drain on its top outer peripheral surface and its bottom outer peripheral surface SO as to communicate with the internal space to discharge moisture therefrom.

The upper drain and the lower drain may each have a moisture outlet formed horizontally and a shielding end formed to vertically shield the moisture outlet.

The multifunction link assembly may further include a cable receiving pipe installed to accommodate and pass the multi-strand coaxial cable therethrough in a concealed manner and having one end connected to the radio unit and the other end connected to the steering ball joint part.

The steering ball joint part may include a steering outer support having one end connected to the cable receiving pipe and the other end bent at a predetermined angle with respect to its longitudinal direction to extend toward a rear steering inlet of the rotating housing, and a steering inner joint extending from the other end of the steering outer support, having an outer peripheral surface curvedly extending at left and right tips thereof about an arbitrary steering rotation point formed in the rotating housing, and accommodated in the internal space of the rotating housing. The left and right tips of the steering inner joint may extend at least to a position exceeding 180 degrees about the arbitrary steering rotation point.

The tilting ball joint part may include a tilting outer support having one end connected to a female connector formed on the back of the antenna module and the other end extending toward a front tilting inlet of the rotating housing, and a tilting inner joint extending from the other end of the tilting outer support, having an outer peripheral surface curvedly extending at upper and lower tips thereof about an arbitrary tilting rotation point formed in the rotating housing, and accommodated in the internal space of the rotating housing. The upper and lower tips of the tilting inner joint may extend at least to a position exceeding 180 degrees about the arbitrary tilting rotation point.

The multifunction link assembly may further include at least one fixing means fixed; through the rotating housing and placed on a rotation path of the steering inner joint or the tilting inner joint to interfere therewith. The at least one fixing means may be a headless bolt installed so that its outer end does not protrude outside the rotating housing.

The steering outer support may be provided at a portion thereof with a joining panel that is manufactured separately and then joined for installation of the multi-strand coaxial cable therein, and the joining panel may be joined by either adhesive bonding or welding bonding.

### ADVANTAGEOUS EFFECTS

A multifunction link assembly for small cell base station antenna apparatuses according to exemplary embodiments of the present disclosure can achieve various effects as follows.

Firstly, it is possible to facilitate establishment of small cell base stations since an antenna module is easily controlled in directionality even in narrow spaces.

Secondly, it is possible to prevent a poor aesthetic appearance (aesthetic external appearance) by having controllable directionality without exposure of various cables for electrical connection between a radio unit and an antenna module to the outside.

Thirdly, it is possible to compactly install a tilting ball joint and a steering ball without ensuring an additional installation space, and to ensure a wide range of directional control angles of a plurality of antenna modules with respect to the radio unit through angle control by each ball joint.

### BRIEF DESCRIPTION OF DRAWINGS

FIG. 1 is a perspective view illustrating a state of installation of an antenna module to a radio unit using a multifunction link assembly for small cell base station antenna apparatuses according to an embodiment of the present disclosure.

FIGS. 2A and 2B are front and rear perspective views illustrating the configuration of FIG. 1, excluding the radio unit.

FIGS. 3A and 3B are exploded perspective views of FIGS. 2A and 2B, respectively.

FIG. 4 is a cross-sectional view taken along line B-B of FIG. 2A.

FIG. 5 illustrates front and rear cutaway perspective views taken along line B-B of FIG. 2A.

FIGS. 6A and 6B are exploded perspective views illustrating the multifunction link assembly for small cell base station antenna apparatuses according to the embodiment of the present disclosure.

FIGS. 7A and 7B are vertical and horizontal cross-sectional views illustrating the multifunction link assembly for small cell base station antenna apparatuses according to the embodiment of the present disclosure.

FIGS. 8A and 8B are vertical and horizontal cross-sectional views illustrating antenna module states after tilting rotation in FIG. 7A and after steering rotation in FIG. 7B, respectively.

### LIST OF REFERENCE NUMERALS

A: antenna module RRH: remote radio head (radio unit)
100: multifunction link assembly 110: rotating housing
130: tilting ball joint part 131: tilting outer support
132: tilting inner joint 140: steering ball joint part
141: steering outer support 142: steering inner joint
150: cable receiving pipe 160: coaxial cable 170A, 170R: male connector T.C: tilting rotation point
S.C: steering rotation point

### Best Model

Hereinafter, a multifunction link assembly for small cell base station antenna apparatuses according to exemplary embodiments of the present disclosure will be described in detail with reference to the accompanying drawings.

It should be noted that reference numerals are added to the components of the accompanying drawings to facilitate understanding of the embodiments described below and the same reference numbers will be used throughout the drawings to refer to the same or like parts wherever possible. In certain embodiments, detailed descriptions of constructions or functions well known in the art may be omitted to avoid obscuring appreciation of the disclosure by a person of ordinary skill in the art.

The terms such as “first”, “second”, “A”, “B”, “(a)”, and “(b)” may be used herein to describe components in the embodiments of the present disclosure. These terms are not used to define an essence, order or sequence of a corresponding component but used merely to distinguish the corresponding component from other component(s). Unless otherwise defined, all terms, including technical and scientific terms, used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

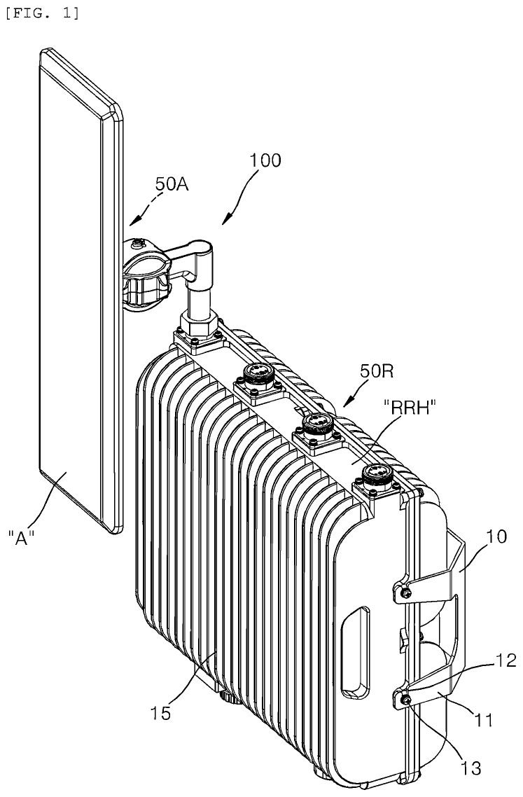

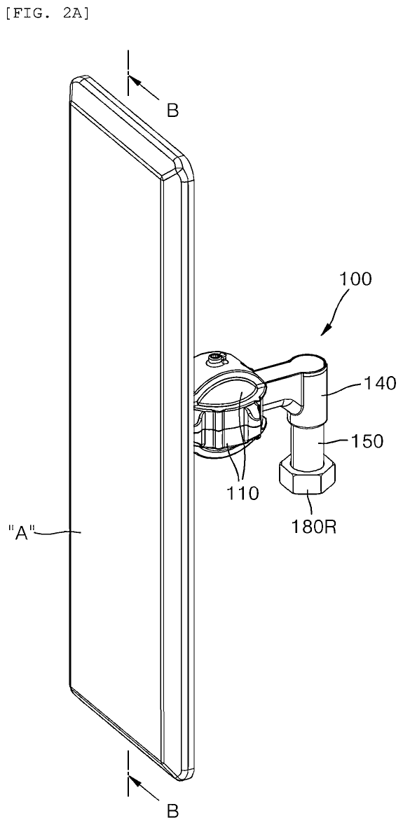

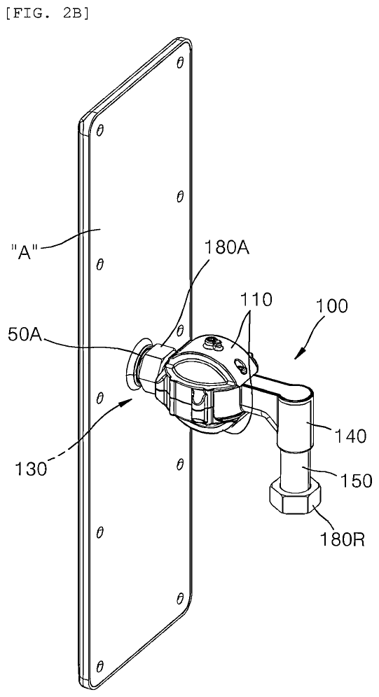

FIG. 1 is a perspective view illustrating a state of installation of an antenna module to a radio unit using a multifunction link assembly for small cell base station antenna apparatuses according to an embodiment of the present disclosure. FIGS. 2A and 2B are front and rear perspective views illustrating the configuration of FIG. 1, excluding the radio unit.

As illustrated in FIGS. 1 to 2B, the multifunction link assembly for small cell base station antenna apparatuses, which is designated by reference numeral 100, according to the embodiment of the present disclosure serves to mediate physical coupling and electrical connection between a radio unit (e.g., remote radio head (RRH)) and an antenna module A in the configuration of a small cell base station antenna apparatus installed in a predetermined place.

Here, the predetermined place where the small cell base station antenna apparatus according to the present disclosure is installed may refer to a public place, a densely populated area, or a place such as a large shopping mall or an airport building, for performing the function as a small cell base station, and may be a structure suitable for in-building (indoor) installation, such as of a support-pole-mounted type, a wall-mounted type, or a ceiling-mounted type, depending on the type of installation of the small cell base station antenna apparatus.

The antenna module A may refer to an antenna module having at least one frequency band. The radio unit RRH may refer to a device that is connected to an antenna for each frequency band provided in the antenna module A for transmission/reception between the antenna and the base station. The radio unit RRH is a relay device that performs functions such as receiving weakened signals to amplify or retransmit them, formalizing distorted waveforms, and readjusting timing between a base station and a mobile communication terminal in a mobile communication system.

In the configuration of the small cell base station antenna apparatus, the radio unit RRH may be mounted on a structure such as a support pole, a wall, or a ceiling in an indoor space (house) via a mounting bracket 10, as illustrated in FIG. 1.

For this purpose, while being securely coupled to the above-mentioned structure or the like, the mounting bracket 10 may be fixed to multiple locations at both left and right ends of the radio unit RRH using fixing screws 13 through screw fastening grooves 12 formed on screw fastening ends 11 bent to protrude forwards from left and right sides.

The radio unit RRH may have a plurality of heat sink fins 15 formed integrally on the front of a front housing (not shown) thereof or on the back of a rear housing (not shown) thereof, so as to dissipate heat generated in a predetermined space to the outside through the heat sink fins 15.

The multifunction link assembly for small cell base station antenna apparatuses 100 according to the present disclosure serves to mediate coupling of at least one antenna module A to the radio unit RRH, as illustrated in FIGS. 1 to 2B.

More specifically, one or more female connectors 50A and 50R may be arranged on one portion of the radio unit RRH and one portion of the at least one antenna module A, respectively, to mediate connection with the multifunction link assembly for small cell base station antenna apparatuses 100 according to the embodiment of the present disclosure.

Here, the female connector 50R provided on the radio unit RRH may be placed in an area formed by removing some of the heat sink fins 15 integrally formed on the front or back of the radio unit RRH. Of course, it may also be placed on any of the left and right sides and the lower surface of the radio unit.

However, it will be described that the female connector 50R is placed on the upper surface of the radio unit RRH, as illustrated in FIGS. 1 to 2B, in the multifunction n link assembly for small cell base station antenna apparatuses 100 according to the embodiment of the present disclosure.

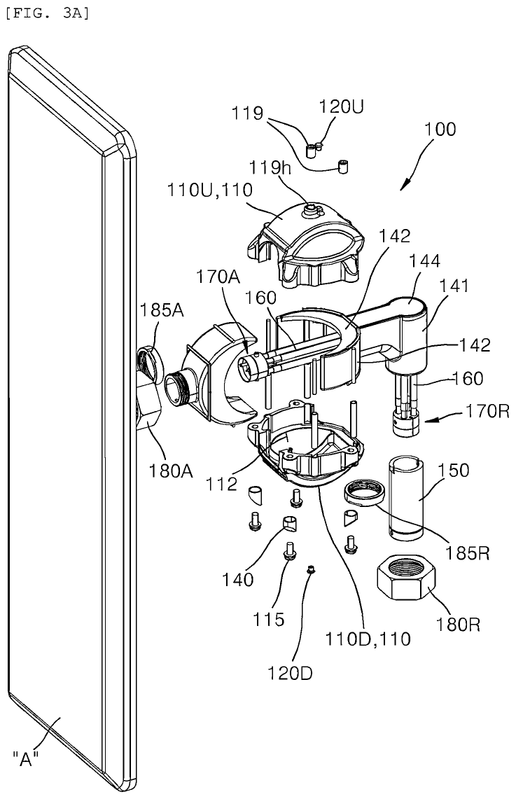

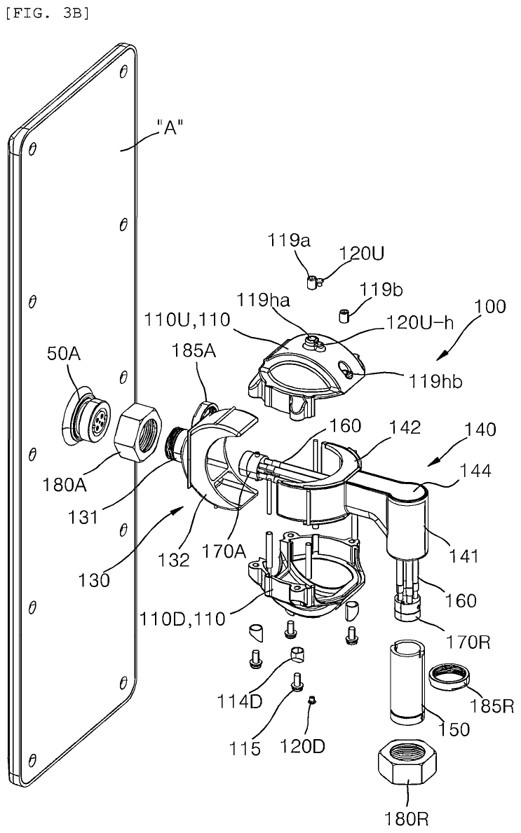

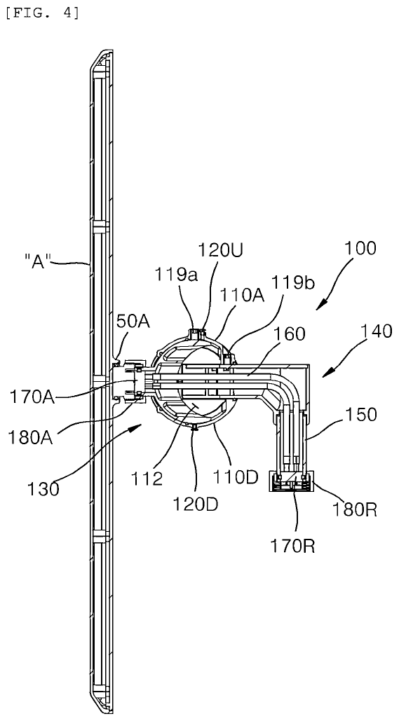

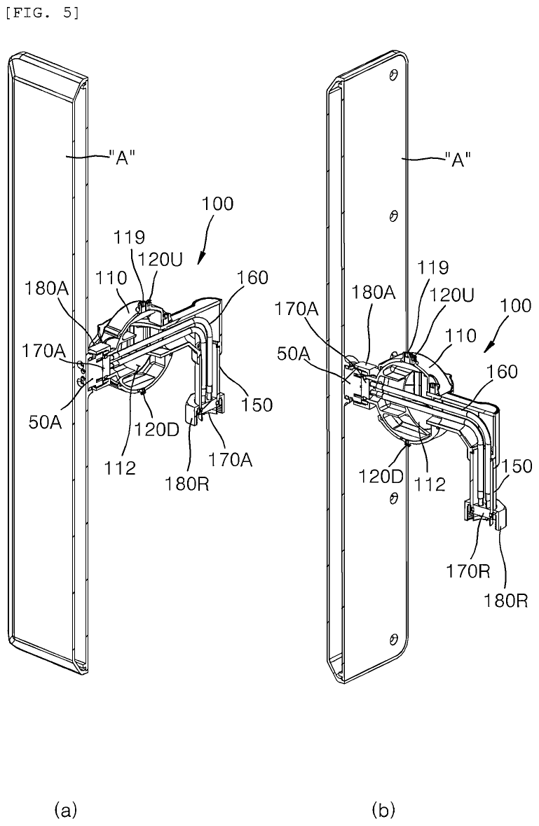

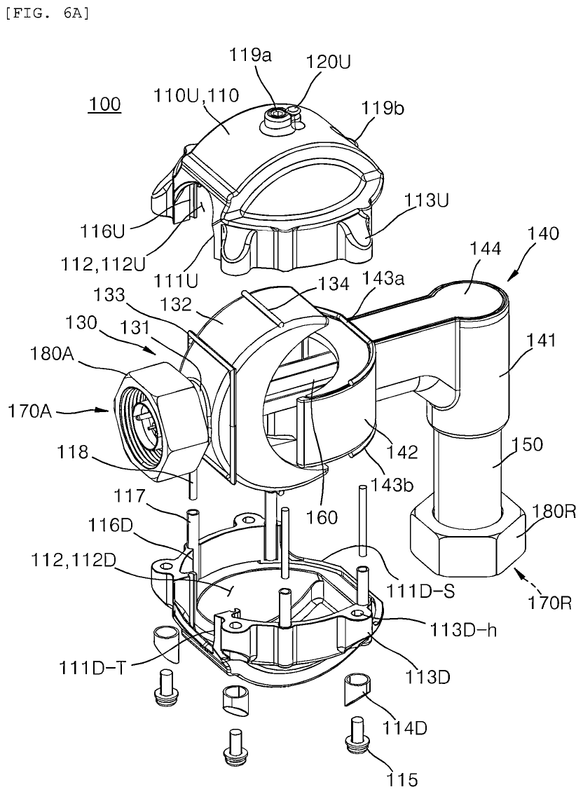

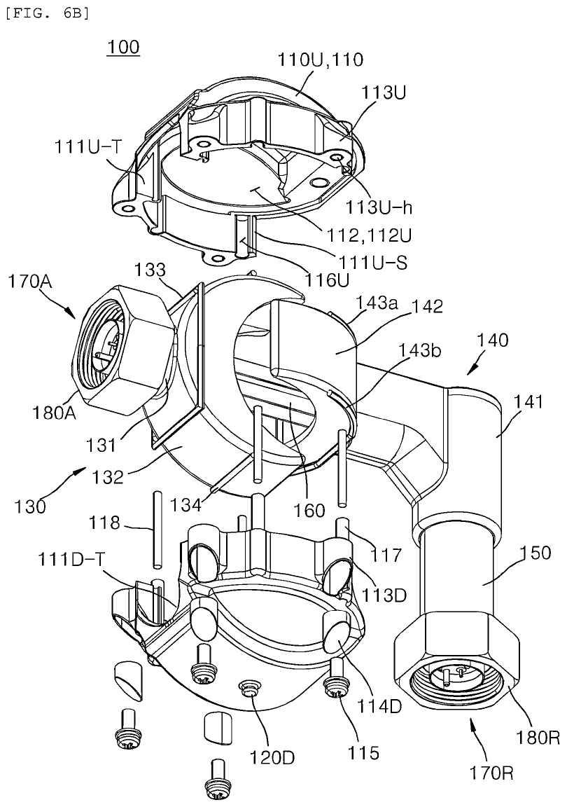

FIGS. 3A and 3B are exploded perspective views of FIGS. 2A and 2B, respectively. FIG. 4 is a cross-sectional view taken along line B-B of FIG. 2A. FIG. 5 illustrates front and rear cutaway perspective views taken along line B-B of FIG. 2A. FIGS. 6A and 6B are exploded perspective views illustrating the multifunction link assembly for small cell base station antenna apparatuses according to the embodiment of the present disclosure.

As illustrated in FIGS. 3A to 6B, the multifunction link assembly for small cell base station antenna apparatuses 100 according to the embodiment of the present disclosure includes a rotating housing 110 that is rotatably provided in parallel to at least one surface of the radio unit RRH and has an internal space for accommodating a multi-strand coaxial cable 160 provided for electrical connection between the radio unit RRH and the at least one antenna module A and passing the multi-strand coaxial cable 160 therethrough in back and forth directions, a steering ball joint part 140 that is coupled to the rear of the rotating housing 110 to provide a center of left-right steering rotation of the rotating housing 110, and a tilting ball joint part 130 that is coupled to the front of the rotating housing 110 so as to be tiltable and rotatable in the back and forth directions with respect to the rotating housing 110.

Here, the rotating housing 110 may have an internal space 112 that is open in the back and forth directions. Hereinafter, the front of the rotating housing 110 that is open to communicate with the internal space 112 thereof will be referred to as a “front tilting inlet 111U-T or 111D-T”, and the rear of the rotating housing 110 that is open to communicate with the internal space 112 thereof will be referred to as a “rear steering inlet 111U-S or 111D-S”.

The steering ball joint part 140 may be coupled to the internal space 112 through the rear steering inlet 111U-S or 111D-S at the open rear of the rotating housing 110, and may serve to guide the rotating housing 110 to be steerable and rotatable in left and right directions about an arbitrary rotation center point S.C (hereinafter, referred to as a “steering rotation point”) in the internal space 112.

The tilting ball joint part 130 may be coupled to the internal space 112 through the front tilting inlet 111U-T or 111D-T at the open front of the rotating housing 110, and may be provided so that the front end thereof to which the antenna module A is coupled is tiltable and rotatable in up and down directions about an rotation center point T.C (hereinafter, referred to as a “tilting rotation point”) in the internal space 112 while being guided by the rotating housing 110.

The steering rotation point S.C and the tilting rotation point T.C may be set at the same position in the internal space 112 of the rotating housing 110.

More specifically, the steering ball joint part 140 may have at least a portion of a circular outer peripheral surface concentric with the inner peripheral surface of the rotating housing 110, and the outer peripheral surface of the steering ball joint part 140 may be formed to have the steering rotation point S.C about which the rotating housing 110 is steered and rotated in the left and right directions. The tilting ball joint part 130 may have at least a portion of a circular outer peripheral surface concentric with the inner peripheral surface of the rotating housing 110, and the outer peripheral surface of the tilting ball joint part 130 may be formed to have the tilting rotation point T.C about which the tilting ball joint part 130 is tilted and rotated in the up and down directions with respect to the rotating housing 110.

The at least one antenna module A may be adjusted for steering rotation in conjunction with the angle of left-right steering rotation of the rotating housing 110, and may be adjusted for tilting rotation in conjunction with the angle of front-back tilting rotation of the tilting ball joint part 130 with respect to the rotating housing 110.

In other words, the steering rotation of the antenna module A may be adjusted by rotating the rotating housing 110 relative to the fixed steering ball joint part 140 and at the same time rotating the tilting ball joint part 130 placed in the front of the rotating housing 110 in conjunction therewith.

In addition, the tilting rotation of the antenna module A coupled to the front of the rotating housing 110 may be adjusted by rotating the tilting ball joint part 130 relative to the fixed rotating housing 110 when the adjustment of the steering rotation of the antenna module A has been completed (finished).

As illustrated in FIGS. 3A and 3B, the rotating housing 110 may have the internal space 112 for accommodating some of the components of the tilting ball joint part 130 and the steering ball joint part 140 (tilting inner joint 132 and steering inner joint 142 to be described later), and may include an upper housing 110U located at the top thereof and a lower housing 110D located at the bottom thereof.

The above-mentioned internal space may be defined between the upper housing 110U and the lower housing 110D. The front tilting inlet 111U-T or 111D-T, through which a portion of the tilting ball joint part 130 (tilting inner joint 132) is inserted and accommodated and which gives a limit of tilting rotation of the tilting ball joint part 130, may be formed at the front of the boundary where the upper housing 110U and the lower housing 110D are coupled to each other. The rear steering inlet 111U-S or 111D-S, through which a portion of the steering ball joint part 140 (steering inner joint 142) is inserted and accommodated and which gives a limit of steering rotation of the steering ball joint part 140, may be formed at the rear of the boundary where the upper housing 110U and the lower housing 110D are coupled to each other.

The multifunction link assembly for small cell base station antenna apparatuses 100 according to the embodiment of the present disclosure may further include a multi-strand coaxial cable 160 provided for electrical connection between the radio unit RRH and the antenna module A.

The multi-strand coaxial cable 160 may be connected to the antenna module A through all of the steering ball joint part 140, the rotating housing 110, and the tilting ball joint part 130 from the radio unit RRH.

As illustrated in FIGS. 3A to 6B, the multifunction link assembly for small cell base station antenna apparatuses 100 according to the embodiment of the present disclosure may further include a cable receiving pipe 150 installed to accommodate and pass the multi-strand coaxial cable 160 therethrough in a concealed manner and having one end connected to the radio unit RRH and the other end connected to the steering ball joint part 140.

The steering ball joint part 140 may include a steering outer support 141 having one end connected to the cable receiving pipe 150 and the other end bent at a predetermined angle with respect to the longitudinal direction thereof to extend toward the rear steering inlet 111U-S or 111D-S of the rotating housing 110, and a steering inner joint 142 extending from the other end of the steering outer support 141, having an outer peripheral surface curvedly extending at the left and right tips thereof about an arbitrary steering rotation point S.C formed in the rotating housing 110, and accommodated in the internal space 112 of the rotating housing 110.

It is preferable that the left and right tips of the steering inner joint 142 extend at least to a position exceeding 180 degrees about the arbitrary steering rotation point S.C.

The steering outer support 141 is provided at a portion thereof with a joining panel 144 that is manufactured separately and then joined for installation of the multi-strand coaxial cable 160 therein. The joining panel 144 may be joined by either adhesive bonding or welding bonding after installation of the coaxial cable 160 therein.

Male connectors 170A and 170R each having a somewhat larger diameter are soldered to respective tips of the multi-strand coaxial cable 160 for facilitating electrical connection with the female connector 50A fixed to the back of the antenna module A and the female connector 50R fixed to the radio unit RRH. Accordingly, the joining panel 144 is manufactured separately and then joined to facilitate insertion and installation into the bent portion of the steering outer support 141.

The tilting ball joint part 130 may include a tilting outer support 131 having one end connected to the female connector 50A formed on the back of the antenna module A and the other end extending toward the front tilting inlet 111U-T or 111D-T of the rotating housing 110, and a tilting inner joint 132 extending from the other end of the tilting outer support 131, having an outer peripheral surface curvedly extending at the upper and lower tips thereof about an arbitrary tilting rotation point T.C formed in the rotating housing 110, and accommodated in the internal space 112 of the rotating housing 110.

It is preferable that the upper and lower tips of the tilting inner joint 132 extend at least to a position exceeding 180 degrees about the arbitrary tilting rotation point T.C.

In other words, the tilting ball joint part 130 and the steering ball joint part 140 may include the tilting inner joint 132 and the steering inner joint 142, respectively, which are accommodated in the internal space 112 of the rotating housing 110.

However, the tilting ball joint part 130 and the steering ball joint part 140 may be arranged so as not to interfere with each other in the internal space 112 of the rotating housing 110 during steering rotation and tilting rotation, even when the tips of the tilting inner joint 132 and the steering inner joint 142 extend to a position exceeding 180 degrees about the tilting rotation point T.C and the steering rotation point S.C, respectively.

The tilting inner joint 132 and the steering inner joint 142 may be coupled in contact with the inner surface of the rotating housing 110 with a frictional force that allows rotation thereof only with respect to an additional external force provided after they are adjusted to the angle of steering rotation and the angle of tilting rotation with respect to the rotating housing 110 while the antenna module A is mounted.

This is to, while including all of the self-load of the antenna module A, allow an operator to perform a pre-stop function for preventing the tilting inner joint and the steering inner joint from rotating arbitrarily unless an additional external force is applied during adjustment of the steering rotation or tilting rotation thereof.

For this purpose, at least one friction sealing member 133/134/143a/143b may be interposed among the tilting inner joint 132, the steering inner joint 142, and the rotating housing 110.

The friction sealing member 133/134/143a/143b may include one or more waterproof seals 133, 143a, and 143b installed at the front tilting inlet 111U-T or 111D-T of the rotating housing 110 and the rear steering inlet 1110-S or 1110-S of the rotating housing 110 through which the tilting inner joint 132 and the steering inner joint 142 are inserted, and one or more friction rollers 134 and 117 rolled in the direction of rotation of the tilting inner joint 132 and the steering inner joint 142.

Among the friction rollers 134 and 117, the friction roller 134 provided in the tilting inner joint 132 may be in the form of a rod rolled in the direction of tilting rotation on the outer peripheral surface of the tilting inner joint 132. Among the friction rollers 134 and 117, the friction roller 117 provided in the steering inner joint 142 may be inserted and installed into a friction member installation groove 116U or 116D formed on the inner surface of the edge between the upper housing 110U and the lower housing 110D. Here, the friction roller 117 may be a member that is made of Teflon material and filled with rubber material therein.

The multifunction link assembly for small cell base station antenna apparatuses 100 according to the embodiment of the present disclosure may further include at least one fixing means 119a/119b fixed through the rotating housing 110 and placed on the rotation path of the steering inner joint 142 or the tilting inner joint 132 to interfere therewith.

Here, the at least one fixing means 119a/119b may be adopted as a headless bolt installed so that the outer end thereof does not protrude outside the rotating housing 110.

Thus, the operator may stably adjust the directionality of the antenna module A by means of the tilting inner joint 132 and the steering inner joint 142 coupled in the rotating housing 110 to have the pre-stop function, and then finally complete the adjustment of the directionality of the antenna module A using the fixing means 119a/119b adopted as the headless bolt.

The at least one fixing means 119a/119b may include a tilting fixture 119a provided to be in contact with or interfere with the outer peripheral surface of the tilting inner joint 132 accommodated in the internal space 112 of the rotating housing 110, and a steering fixture 119b provided to be in contact with or interfere with the outer peripheral surface of the steering inner joint 142 accommodated in the internal space 112 of the rotating housing 110.

As illustrated in FIGS. 3A to 6B, in the multifunction link assembly for small cell base station antenna apparatuses 100 according to the embodiment of the present disclosure, the rotating housing 110 may be further provided with an upper drain 120U and a lower drain 120D on the top outer peripheral surface and the bottom outer peripheral surface thereof so as to communicate with the internal space 112 to discharge moisture therefrom.

The upper drain 120U and the lower drain 120D each have a moisture outlet (not shown) formed horizontally to actually discharge moisture (water) therethrough, and a shielding end (not shown) formed to vertically shield the moisture outlet, with the consequence that it is difficult for moisture such as rainwater to flow into the rotating housing 110 from the outside, while the moisture that has once flowed into the rotating housing 110 is easily discharged through the moisture outlet that is open horizontally.

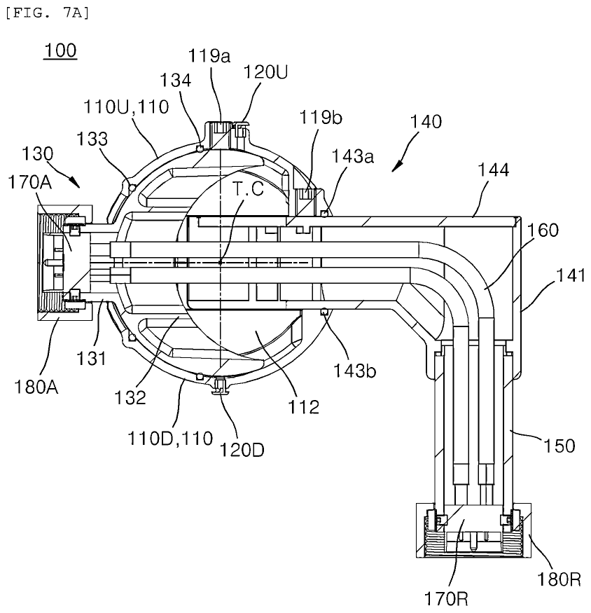

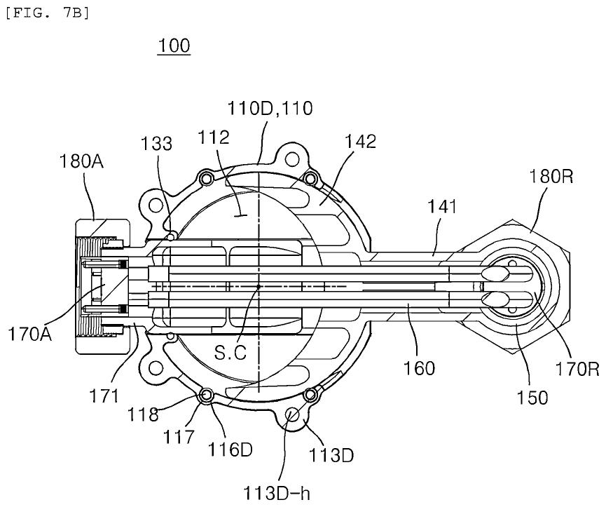

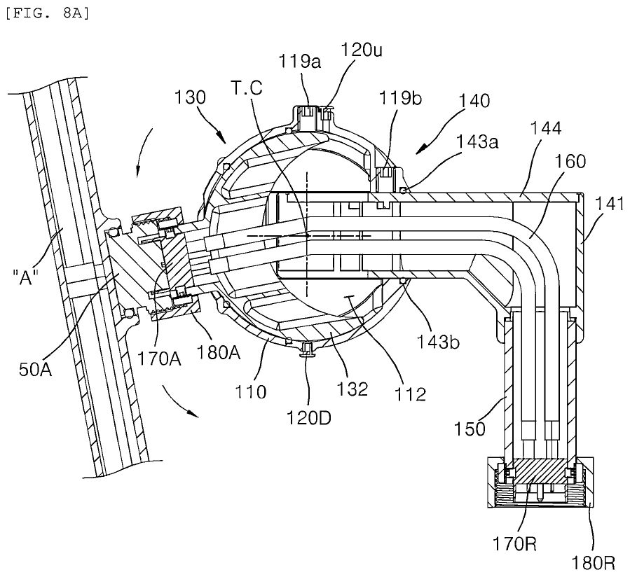

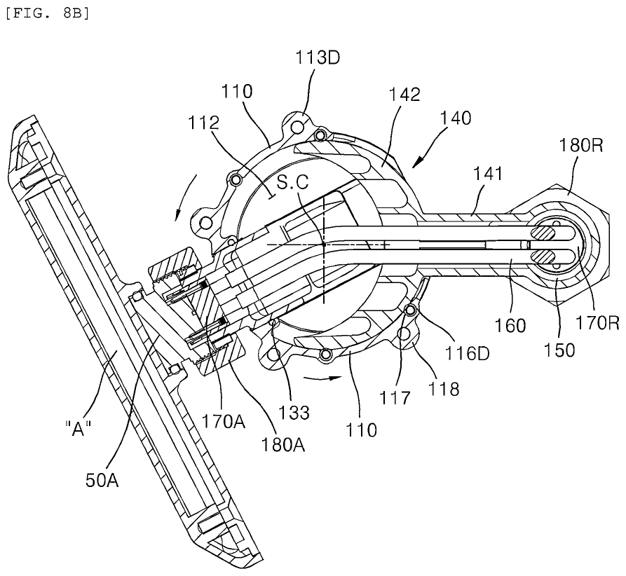

FIGS. 7A and 7B are vertical and horizontal cross-sectional views illustrating the multifunction link assembly for small cell base station antenna apparatuses according to the embodiment of the present disclosure. FIGS. 8A and 8B are vertical and horizontal cross-sectional views illustrating antenna module states after tilting rotation in FIG. 7A and after steering rotation in FIG. 7B, respectively.

The tilting rotation motion and steering rotation motion of the antenna module A using the multifunction link assembly for small cell base station antenna apparatuses 100 according to the embodiment of the present disclosure configured as described above will be briefly described as follows.

First, as illustrated in FIGS. 7A and 8A, the antenna module A is coupled via the tilting ball joint part 130, and the tilting ball joint part 130 is fixed to the internal space 112 of the rotating housing 110 via the fixing means 119a. In this state, when an on-site operator releases the fixed state of the tilting ball joint part 130 via the fixing means 119a for adjustment of the tilting of the antenna module A, and then applies an external force to the antenna module A in either the up or down direction, the tilting ball joint part 130 is tilted and rotated at the front end thereof in the up or down direction while being guided by the internal space 112 of the rotating housing 110.

The adjustment of the tilting rotation may be completed by the on-site operator adjusting the antenna module A to a desired angle of tilting, and then stably fixing the tilting ball joint part 130 inside the rotating housing 110 using the fixing means 119a again.

Next, as illustrated in FIGS. 7B and 8B, in the state where the rotating housing 110 is fixed via the steering ball joint part 140, when the on-site operator releases the fixed state of the rotating housing 110 via the fixing means 119b for adjustment of the steering of the antenna module A, and then applies an external force to the antenna module A in either the left or right direction, the rotating housing 110 is steered and rotated in the left or right direction while being guided by the steering ball joint part 140.

Likewise, the adjustment of the steering rotation may be completed by the on-site operator adjusting the antenna module A to a desired angle of steering, and then fixing the rotating housing 100 to the steering ball joint part 140 using the fixing means 119b again.

As such, the multifunction link assembly for small cell base station antenna apparatuses 100 according to the embodiment of the present disclosure has an advantage of improving workability and preventing a poor aesthetic appearance since the tilting inner joint 132 of the tilting ball joint part 130 and the steering inner joint 142 of the steering ball joint part 140 are compactly arranged so as not to interfere with each other in rotation in the internal space 112 of the rotating housing 110, and are stably fixed by means of the fixing means 119a/119b after the adjustment of steering rotation and the adjustment of tilting rotation, respectively.

The multifunction link assembly for small cell base station antenna apparatuses 100 according to the exemplary embodiments of the present disclosure has been described in detail above with reference to the accompanying drawings. However, the exemplary embodiments of the present disclosure should not be construed as limiting the technical idea of the disclosure. It will be apparent to those skilled in the art that the scope of the present disclosure is limited only by the appended claims and various variations and modifications may be made without departing from the spirit and scope of the disclosure. Therefore, the true scope of rights of the present disclosure should be defined by the appended claims.

### INDUSTRIAL APPLICABILITY

The present disclosure is directed to a multifunction link assembly for small cell base station antenna apparatuses, which is capable of facilitating establishment of small cell base stations in public places, densely populated areas, or places such as large shopping malls or airport buildings, of preventing a poor aesthetic appearance (aesthetic external appearance) by having controllable directionality without exposure of various cables for electrical connection between a radio unit and an antenna module to the outside, of achieving dual banding in various places by dividing a portion of one antenna module to cover different frequency bands or by providing a plurality of antenna modules to cover respective different frequency bands, and of ensuring a wide range of directional control angles.

1. A multifunction link assembly for small cell base station antenna apparatuses, comprising:
a rotating housing having an internal space that is open in back and forth directions;
a steering ball joint part coupled to the internal space at the open rear of the rotating housing, and configured to guide the rotating housing to be steerable and rotatable in left and right directions about an arbitrary rotation center point (hereinafter, referred to as a “steering rotation point”) in the internal space;
a tilting ball joint part coupled to the internal space at the open front of the rotating housing, and having a front end to which an antenna module is coupled, the front end being tilted and rotated in up and down directions about an arbitrary rotation center point (hereinafter, referred to as a “tilting rotation point”) in the internal space while being guided by the rotating housing; and
a multi-strand coaxial cable provided for electrical connection between a radio unit (e.g., remote radio head (RRH)) and the antenna module,
wherein the multi-strand coaxial cable is connected to the antenna module through all of the steering ball joint part, the rotating housing, and the tilting ball joint part from the radio unit.

2. The multifunction link assembly according to claim 1, wherein the steering rotation point and the tilting rotation point are set at the same position in the internal space.

3. The multifunction link assembly according to claim 1, wherein the steering ball joint part and the tilting ball joint part are arranged so as not to interfere with each other in the internal space during steering rotation and tilting rotation.

4. The multifunction link assembly according to claim 1, wherein:
the steering ball joint part has at least a portion of a circular outer peripheral surface that is concentric with an inner peripheral surface of the rotating housing; and
the outer peripheral surface is formed to have the steering rotation point about which the rotating housing is steered and rotated in the left and right directions.

5. The multifunction link assembly according to claim 1, wherein:
the tilting ball joint part has at least a portion of a circular outer peripheral surface that is concentric with an inner peripheral surface of the rotating housing; and
the outer peripheral surface is formed to have the tilting rotation point about which the tilting ball joint part is tilted and rotated in the up and down directions with respect to the rotating housing.

6. The multifunction link assembly according to claim 1, wherein the antenna module is adjusted for steering rotation in conjunction with an angle of left-right steering rotation of the rotating housing, and is adjusted for tilting rotation in conjunction with an angle of up-down tilting rotation of the tilting ball joint part with respect to the rotating housing.

7. The multifunction link assembly according to claim 1, wherein:
the tilting ball joint part and the steering ball joint part comprise respective inner joints accommodated in the internal space of the rotating housing; and
the inner joints are in contact with an inner surface of the rotating housing with a frictional force that allows rotation thereof only with respect to an additional external force provided after they are adjusted to an angle of steering rotation and an angle of tilting rotation with respect to the rotating housing while the antenna module is mounted.

8. The multifunction link assembly according to claim 7, wherein at least one friction sealing member is interposed between the inner joints and the rotating housing.

9. The multifunction link assembly according to claim 8, wherein the friction sealing member comprises one or more waterproof seals installed at a front tilting inlet of the rotating housing as the open front of the rotating housing and at a rear steering inlet of the rotating housing as the open rear of the rotating housing, through which the inner joints are inserted, and one or more friction rollers rolled in a direction of rotational of the inner joints.

10. The multifunction link assembly according to claim 1, wherein the rotating housing is provided with an upper drain and a lower drain on its top outer peripheral surface and its bottom outer peripheral surface so as to communicate with the internal space to discharge moisture therefrom.

11. The multifunction link assembly according to claim 10, wherein the upper drain and the lower drain each have a moisture outlet formed horizontally and a shielding end formed to vertically shield the moisture outlet.

12. The multifunction link assembly according to claim 1, further comprising a cable receiving pipe installed to accommodate and pass the multi-strand coaxial cable therethrough in a concealed manner and having one end connected to the radio unit and the other end connected to the steering ball joint part.

13. The multifunction link assembly according to claim 12, wherein the steering ball joint part comprises:
a steering outer support having one end connected to the cable receiving pipe and the other end bent at a predetermined angle with respect to its longitudinal direction to extend toward a rear steering inlet of the rotating housing; and
a steering inner joint extending from the other end of the steering outer support, having an outer peripheral surface curvedly extending at left and right tips thereof about an arbitrary steering rotation point formed in the rotating housing, and accommodated in the internal space of the rotating housing, and
wherein the left and right tips of the steering inner joint extend at least to a position exceeding 180 degrees about the arbitrary steering rotation point.

14. The multifunction link assembly according to claim 12, wherein the tilting ball joint part comprises:
a tilting outer support having one end connected to a female connector formed on the back of the antenna module and the other end extending toward a front tilting inlet of the rotating housing; and
a tilting inner joint extending from the other end of the tilting outer support, having an outer peripheral surface curvedly extending at upper and lower tips thereof about an arbitrary tilting rotation point formed in the rotating housing, and accommodated in the internal space of the rotating housing, and
wherein the upper and lower tips of the tilting inner joint extend at least to a position exceeding 180 degrees about the arbitrary tilting rotation point.

15. The multifunction link assembly according to claim 13, further comprising at least one fixing means fixed through the rotating housing and placed on a rotation path of the steering inner joint or the tilting inner joint to interfere therewith,
wherein the at least one fixing means is a headless bolt installed so that its outer end does not protrude outside the rotating housing.

16. The multifunction link assembly according to claim 13, wherein:
the steering outer support is provided at a portion thereof with a joining panel that is manufactured separately and then joined for installation of the multi-strand coaxial cable therein; and
the joining panel is joined by either adhesive bonding or welding bonding.
